(19) United States
(12) Patent Application Publication
(10) Pub. No.: US 2010/0186561 A1
(43) Pub. Date: Jul. 29, 2010

(54) Device for Separating Winding Cores from Turns of Wound Material in Trimmings of Logs of Web Material

(75) Inventors: Niccolò Brighella, Firenze (IT); Giovanni Brighella, Firenze (IT); Vanni Brighella, Firenze (IT); Mauro Gelli, Lucca (IT)

Correspondence Address: BREINER & BREINER, L.L.C., P.O. BOX 320160, ALEXANDRIA, VA, 22320-0160, US

(73) Assignee: FABIO PERINI S.p.A., Lucca (IT)

(21) Appl. No.: 11/991,748

(22) PCT Filed: Sep. 20, 2006
(86) PCT No.: PCT/IT2006/000668

§ 371 Date: Mar. 10, 2008

(30) Foreign Application Priority Data
Sep. 22, 2005 (IT) FI2005A000197

(51) Int. Cl. B26D 7/06; B65H 73/00; B65G 29/00; B65G 47/84; B26D 7/01; B26D 7/32

(52) U.S. Cl. 83/13; 198/803.12; 198/617; 83/100; 83/102; 83/423; 83/431

(57) ABSTRACT

The device comprises: a moving member (5), positioned around which are engaging elements (9) to axially engage the trimmings (R). The moving member feeds the engaging elements continuously along a closed path, along which a device (20) is provided to detach the turns of web material from the tubular cores.

### TECHNICAL FIELD

The present invention relates to machines for processing web materials, such as paper and tissue paper, and in particular machines intended for production lines of logs of web material wound on tubular winding cores.

In particular, the invention relates to improvements to machines for recovering material from trimmings obtained from cutting the head and tail portions of logs.

### PRIOR ART

In the production of logs of wound web material, in particular logs of tissue paper, such as toilet paper, kitchen towels and the like, a web material of considerable width coming from a parent reel is wound in pre-established quantities around tubular winding cores, generally made of cardboard, plastic or other materials. The logs obtained by means of rewinding machines are trimmed, cutting and discarding the end portions of each log, said portions having edge irregularities due to the irregularities of the longitudinal edges of the web material delivered from the parent reels and to any slight side skidding of the material during winding. This operation to cut the trimmings is generally performed in cutting machines which also cut each log into individual rolls of a length corresponding to the length of the finished rolls intended for use.

Examples of cutting machines are described in EP-A-1268140; EP-A-1268142; EP-A-1230067; U.S. Pat. No. 5,522,292; U.S. Pat. No. 6,786,121; WO-A-2004/004989 and WO-A-2004/039544.

Positioned downstream of the cutting machines are devices which separate the trimmings from the rolls to be packaged. Examples of devices to eliminate trimmings are described in U.S. Pat. No. 5,475,917; U.S. Pat. No. 6,868,958; U.S. Pat. No. 6,915,550; WO-A-03/106122; WO-A-2005/056255.

In some cases the trimmings of the logs are eliminated before the logs are cut into individual rolls. A device to perform trimming before the log is cut into rolls is described in WO-A-2004/014618.

The logs and trimmings are formed of turns of “noble” web material (typically tissue paper) wound around tubes of a poorer material, the sole purpose of which is to support the log formed.

For economic and ecological reasons, it is desirable to recover and recycle the material forming the trimmings. When the winding core is composed of cardboard, the entire trimming can be recovered as paper material. Nonetheless, as the cardboard of the core, formed of poor material, cannot be recycled together with the fiber of the tissue paper to form a new ply of tissue paper, the entire trimming is recovered as low quality paper scrap. This implies an economic loss, as the wound web material, of high quality, could be recycled into a nobler and consequently more costly product.

It therefore becomes necessary to produce a device capable of effectively separating the web material wound externally from the inner tubular core to allow recovery and re-use of the turns of more noble web material separated from the inner winding core.

For this purpose a device has been proposed (see EP-A-1,231,320), wherein pairs of trimmings are engaged axially by mandrels provided with a movement to lift the trimmings from a conveyor surface and transfer the trimmings between two disk blades rotating about two parallel axes of rotation. The cutting edges of the blades are opposed to each other and the blades lie on a common plane orthogonal to the direction of feed of the trimmings. Each trimming is then positioned between the two disk blades, which cut the wound web material without severing the tubular core. The web material is then recovered, while the tubular cores, which remain engaged with the mandrels, are recovered in a different position of the machine.

This device has a complicated structure and a relatively low production rate, incompatible with the high production rates of the rewinding and cutting machines currently on the market.

U.S. Pat. No. 3,245,302 describes a device that recovers the turns of residual web material wound around a tubular winding core coming from unwinding machines, which feed the web material to the rewinding machines. Also in this case the residual turns require to be separated from the tubular winding core. For this purpose the device described in U.S. Pat. No. 3,245,302 has a mandrel onto which the tubular core is inserted with the residual turns of web material wound therearound; a blade provided with a movement parallel to the axis of the mandrel cuts the turns parallel to a generatrix of the tubular core, without cutting the latter. The tubular core remains engaged with the mandrel, while the turns of web material fall and are recovered to be recycled.

This device is not suitable to handle trimmings obtained from cutting the head and tail of logs of web material, which have a much smaller axial length than those characterizing the residual parts of reels which are handled by the device described in U.S. Pat. No. 3,245,302.

### OBJECTS AND SUMMARY OF THE INVENTION

An object of the invention is to produce a device of the aforesaid type, which is of simpler construction and More reliable operation.

In substance, according to a first aspect, the device of the invention comprises: a moving member, positioned around which are engaging elements to axially engage said trimmings, said moving member continuously feeding said engaging elements along a closed path; and along the path of said engaging elements, a device to detach the turns of web material from the tubular core.

The moving member can, for example, be a flexible member, such as a chain, which carries the engaging elements. However, according to a preferred embodiment, the moving member is a rigid or substantially rigid rotor, which carries the engaging elements. This substantially simplifies the structure of the device.

Movement of the engaging elements along a continuous path, and therefore without inversion of motion, makes the device faster and consequently suitable to reach a production rate compatible with the high production speeds of the other machines in the line.

According to an advantageous embodiment, the detaching device has two rotating disk members, positioned on opposite sides of the path of the engaging elements, acting on the trimmings to cause the turns of web material to detach from the tubular core. Advantageously and preferably, the rotating disk members are positioned on two more or less parallel planes, which are spaced apart from each other, between which the path of said engaging elements passes. In practice, the disk members lie on parallel planes, between which the trimmings pass.

At least one of the rotating disk members can be a blade, preferably a toothed blade. The other disk member can, for example and preferably, be a counter disk with a smooth circular edge. These disk members can rotate at different speeds and/or in opposite directions about parallel and optionally coinciding axes, preferably parallel to the axis of rotation of the moving member in the form of a rotor, which supports the trimming engaging elements.

In a practical embodiment, the rotating disk members rotate about axes substantially orthogonal to the axis of the trimmings which pass between said rotating disk members. Advantageously, they can be positioned substantially parallel to each other at a distance less than the outer diameter of the tubular cores of the trimmings.

In an advantageous embodiment the detaching device also includes a counter arm, to oblige the trimmings to pass between the disk members and become deformed. The counter arm can opportunely be positioned between the two rotating disk members to hold each of said trimmings engaged with the respective engaging element when said rotating disk members act thereon. The arm can be elastically stressed towards the moving member, for example by a compression spring, and can be supported oscillating about an axis substantially parallel to the axes of rotation of said rotating disk members.

According to an advantageous embodiment, along the closed path on which the engaging elements move, downstream of the detaching device, brushes are positioned to eliminate any fragments of turns of web material from the tubular cores of the trimmings.

Moreover, a station can be positioned along said closed path for unloading the tubular cores from the engaging elements, wherein said cores are unloaded by gravity.

Advantageously, to recover the material forming the turns of the trimmings, suction members are positioned along said closed path to suck up the web material forming said turns, detached from the tubular cores.

In an advantageous embodiment, the engaging elements are equipped with a movement with respect to the roving member to become engaged with said tubular cores of the trimmings and alternately retract inside the moving member. For example, the engaging elements can be housed slidingly in sliding seats and elastically stressed towards a protracted position, and a shaped profile can be positioned along said closed path to retract the respective engaging elements inside the moving member, releasing them in a position in which the trimmings are fed, elastic protraction of the engaging elements causing their insertion into the cores of the trimmings which are fed sequentially to said position.

According to a different aspect, the invention relates to a method to separate the turns of web material from a winding core in trimmings obtained from cutting the head and tail areas of logs of wound material, in particular, although not exclusively, logs of tissue paper, such as toilet paper, kitchen towels and the like.

In substance, the method according to the invention involves feeding each of the trimmings between two opposed rotating disk members, arranging said two rotating disk members opposite and facing each other and making said two rotating disk members rotate about axes substantially orthogonal to the axes of the trimmings that pass between said two rotating disk members.

According to a practical embodiment of the invention, each of the trimmings is forced between the two rotating disk members and the turns of web material wound around said trimming are cut or torn by at least one of said disk members along a plane substantially tangential to the tubular core.

According to another aspect, the invention relates to a device for handling trimmings of logs of web material wound on tubular cores, to separate turns of said web material from said tubular core, comprising a path along which said trimmings are fed and, along said path, two opposed rotating disk members, i.e. facing each other and positioned on two approximately parallel and spaced apart planes, between; which said trimmings are fed with the respective axes approximately orthogonal to the axes of rotation of the rotating disk members. The distance between the approximately parallel planes on which the two disk members lie is less than the diameter of the tubular cores. Advantageously, trimming engaging elements, which move along a closed path, are made to pass between the two disk members.

Further advantageous characteristics of the device and of the method according to the invention are indicated in the accompanying dependent claims.

### BRIEF DESCRIPTION OF THE DRAWINGS

The invention will now be better understood by following the description and accompanying drawing, which shows a non-limiting practical embodiment of the invention. More specifically, in the drawing:

FIG. 1 shows a longitudinal section, according to a vertical plane, of a first embodiment of the device;

FIG. 2 shows an enlargement of the head of the device, again in a longitudinal section;

FIG. 3 shows a section according to in FIG. 2;

FIGS. 4 and 5 show front views of the area in which the web material is detached from the central winding core, during processing of a trimming in two successive instants of the process;

FIG. 6 shows a cross section similar to the cross section of FIG. 1 of a second embodiment of the device;

FIG. 7 is a plan view according to VII-VII in FIG. 6;

FIG. 8 is a cross section along VIII-VIII in FIG. 7;

FIG. 9 is a detail of the head of the device corresponding to arrow IX in FIG. 7; and

FIG. 10 is a local cross section according to line X-X in FIG. 9.

### DETAILED DESCRIPTION OF THE PREFERRED EMBODIMENT OF THE INVENTION

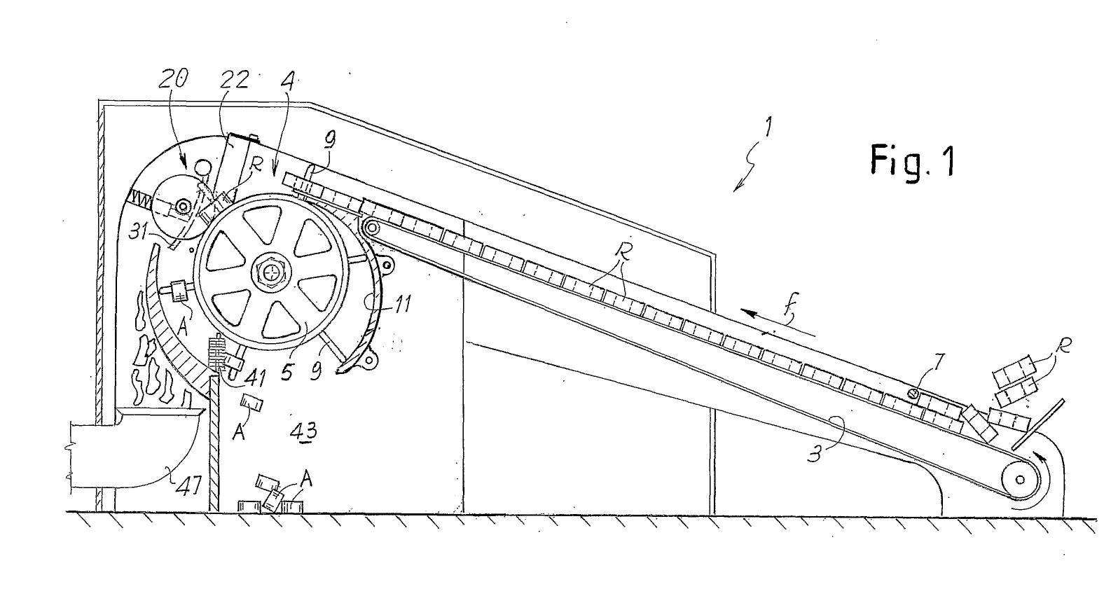

In the example shown in FIGS. 1 to 5 the device, indicated as a whole with 1, has a conveyor belt 3 which collects the trimmings R coming from a cutting machines and from a device (not shown) for eliminating trimmings, unloaded in a lower receiving area of the conveyor belt 3. The individual trimmings R are fed according to the arrow f along a feed trajectory towards a head 4 of the device 1. A bar 7 positioned along the path of the trimmings towards the head 4 ensures that the trimmings R are positioned flat, and not overlapping, with the axis thereof orthogonal to the conveyor belt 3 on which they lie to be fed according to the arrow f towards the head 4 of the device.

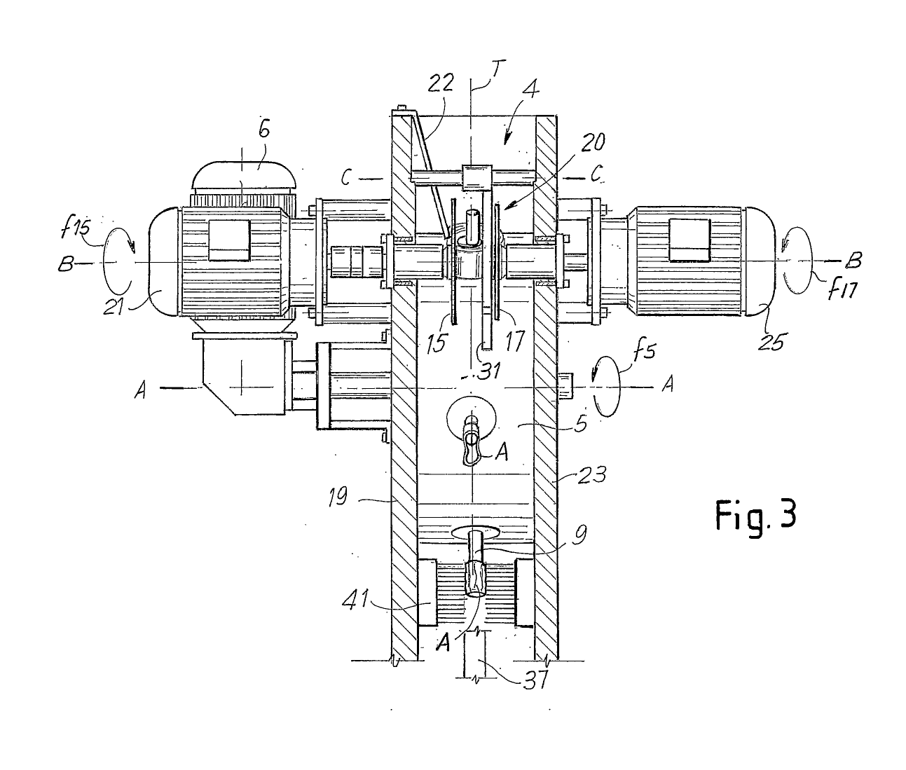

The head 4 has a moving member 5 composed, in this embodiment, of a rotor revolving about a horizontal axis A-A. Rotation of the rotor is imparted by a motor 6 (FIG. 3). Inside the rotor 5 radial seats 8 (six in number in the example shown) are produced, inside which engaging elements 9 in the form of rods or fingers slide, each of which can be inserted axially into the winding core A of each trimming R when it is carried to a specific position above the rotor 5, as will be explained in greater detail hereunder.

The individual engaging elements 9 are guided inside the seats 8 and stressed radially towards the outside by respective compression springs 7.

As can be seen in the drawing, the engaging elements 9 can be in a totally protracted position or can be made to retract gradually inside the respective seats 8 through cooperation between the distal end of each engaging element 9 and a fixed curved surface 11, with an approximately spiral profile, so that each engaging element 9 comes gradually into contact with the surface 11 and, with rotation according to the arrow f5 of the rotor 5, gradual approach of the spiral surface 11 pushes each engaging element 9 inside its respective seat 8, compressing the spring 7.

Two rotating disk members, indicated with 15 and 17, are positioned along the circular trajectory of the engaging elements 9. More specifically, the disk member 15 is a toothed cutting blade, while the disk member 17 is a counter or supporting disk with a smooth edge. Both the disk blade 15 and the disk member 17 are supported rotatingly about a common rotation axis B-B. The toothed disk blade 15 is supported by a first side 19 of the device and is controlled in rotation by a first motor 21 (FIG. 3), also supported by the side 19. The disk member 17, forming the supporting or counter disk, is supported by the side 23 parallel to the side 19 and is controlled in rotation by a motor 25 supported by the side 23.

The two separate motors for the disk members 15 and 17 allow these two members to rotate at different angular speeds and, if necessary, in different directions. In particular, in the example shown, f15 indicates the direction of rotation of the toothed disk blade 15 and f17 indicates the direction of rotation of the counter or supporting disk 17. The path or trajectory, indicated with T, of the engaging elements 9 passes in an intermediate position between the two disk members 15 and 17 and therefore extends on a plane approximately parallel to the planes on which the toothed disk blade 15 and the counter or supporting disk 17 lie.

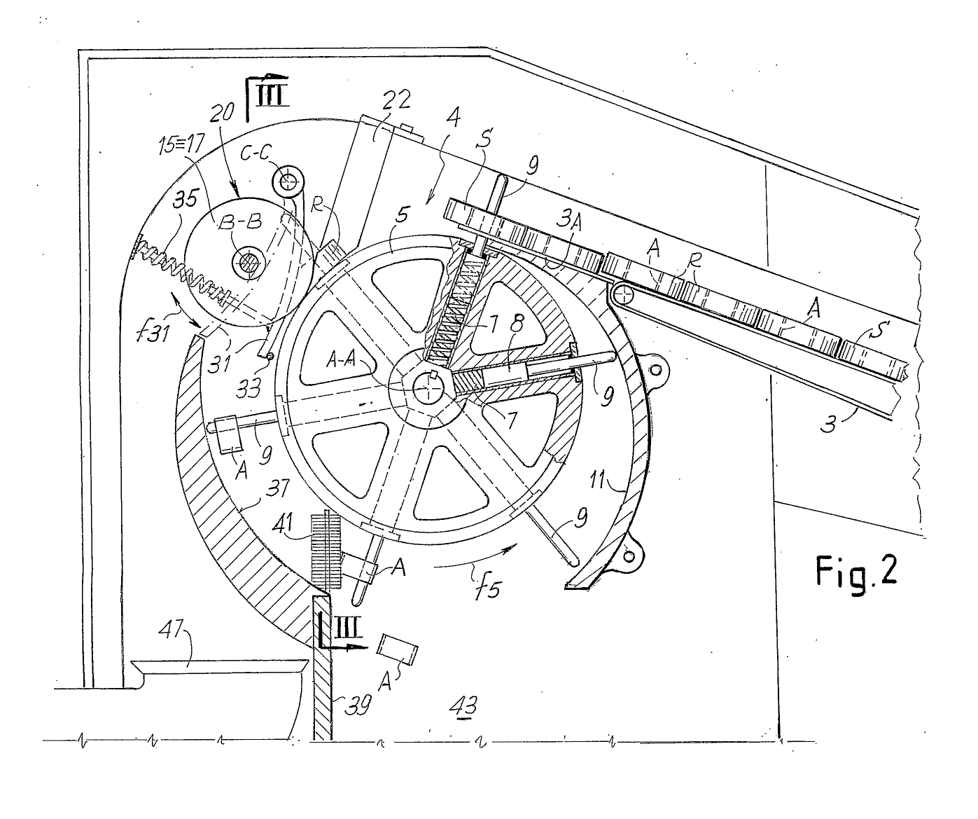

Above the axis B-B of rotation of the motors 21 and 25 and of the respective disk members 15 and 17 is a third axis C-C, parallel to the other axes A-A and B-B, about which a counter arm 31 is oscillatingly mounted, oscillating according to the double arrow f31 and stressed elastically towards a position of maximum closeness to the rotor 5, said position being determinable by fixed stops 33 (FIG. 2), so that even under the thrust of an elastic member 35, indicated schematically in the figures, the counter arm 31 does not press directly against the rotor 5.

As can be seen in the drawing, the oscillating counter arm 31 is positioned between the disk members 15 and 17 in an asymmetrical position, closer to the disk member 17 to leave sufficient space between the counter arm 31 and the toothed disk blade 15 for passage of the engaging elements 9 made to rotate by the rotor 5.

The disk members 15 and 17 and the counter arm 31 are part of a detaching device, indicated as a whole with 20, which separates the turns of web material S wound about the tubular core A of each trimming R fed to the head 3 of the device, with the method to be described hereunder. A guide plate 22 is provided to facilitate insertion of the individual trimmings R between the two disk members 15, 17.

Under the detaching device 20 an arcuate surface 37 extends in the form of a portion of cylindrical surface with axis coinciding with the axis A-A of rotation of the rotor 5 and with a radius equivalent to the radius of the rotor 5 increased by the length by which the engaging elements 9 project from the perimeter surface of the rotor 5 in their position of maximum protraction. The surface 37 extends from the position in which the free end of the oscillating counter arm 31 is located, downwards to a vertical wall 39. Brushes 41 are positioned above this wall 39 to detach any fragments of turns S of web material from the tubular cores A which are fed by the engaging elements 9 to an area in which they are dropped, located under the rotor 5.

The space surrounding the area, in which the detaching device formed by the elements 15, 17 and 31 is positioned, is kept at negative pressure through a suction duct placed in a suitable position, indicated schematically with 47 in the drawing. The turns of web material detached by the detaching device 20 and optionally by the brushes 41 are sucked up through the duct indicated schematically with 47 to separate them from the tubular cores which, instead, are dropped into the space 43, where a collection container, a conveyor belt or the like can be positioned.

The device described hereinbefore operates as follows. The individual trimmings R are carried by the conveyor 3 towards the head 4 of the machine to an inclined surface 3A, which in this example (although not necessarily) is integral with the mechanical member defining the spiral surface 11.

Feed of successive trimmings by the conveyor belt 3 causes the trimmings on the surface 3A to be pushed towards the end corner of said surface. The spiral surface 11, which holds the individual engaging elements 9 inside the respective seats 7 of the rotor 5, also terminates approximately at this end corner or upstream thereof. The surface 3A can have a groove at the level of the engaging elements 9. In this way each engaging element 9 which, through rotation (f5) of the rotor 5, is positioned immediately downstream of the front corner of the surface 3A or at the level of the groove produced therein, is pushed radially out by the rotor 5 and is inserted with wide clearance inside the tubular core 9 of the trimming R which is at that time in the position farthest forward along the feed path of the trimmings from the conveyor 3 to the surface 3A. Movement of the conveyor belt 3 can be controlled with a photocell positioned approximately level with the front corner of the surface 3A, so that it stops each time a trimming R is in this position, to prevent a feed of trimmings R at a rate greater than the rate with which the engaging elements 9 pass from causing the trimmings to accidentally drop into the compartment housing the rotor 5.

The individual trimming R engaged axially by the engaging element 9 is fed along the path of the engaging elements 9 to the area in which the disk members 15 and 17 of the detaching device 20 are positioned.

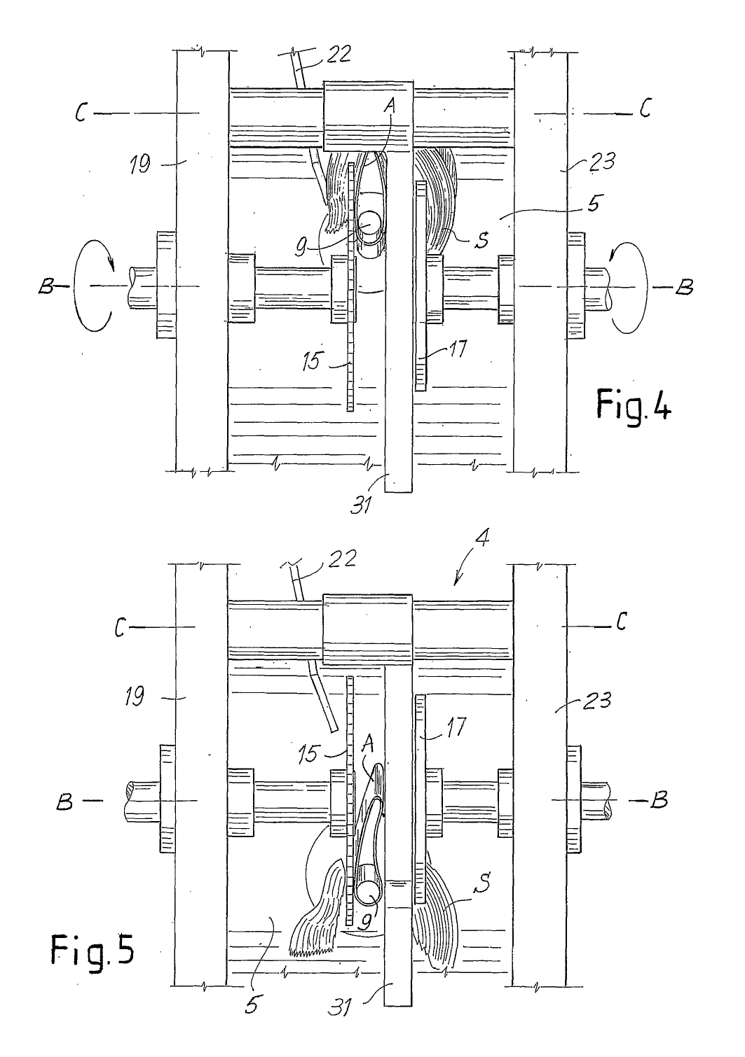

As can be seen in the drawing (FIGS. 4 and 5), while the diameter of the rod shaped engaging elements 9 is substantially less than the inner diameter of the tubular core A, the distance between the two disk members 15, 17 parallel with and facing each other is less than the outer diameter of the tubular cores. Therefore, feed of the engaging elements 9 along the circular trajectory T draws each trimming R, obliging it to penetrate the space between the disk members 15, 17 with consequent deformation of the tubular core A. The oscillating counter arm 31 holds the trimming R against the outer surface of the rotor 5 guaranteeing that said trimming is not lifted through the action of one or other of the disk members 15, 17. Consequently, feed according to the arrow f5 of the trimmings R due to the drawing action by the engaging elements 9 causes the toothed blade 15 to penetrate the turns of web material S wound around the tubular core A causing cutting or tearing of the material, which is detached from the tubular core and sucked into the duct 47. The mouth of said duct can be in any suitable position, even differing from the one indicated schematically in FIG. 1, Moreover, more than one suction duct can also be provided, positioned suitably. The counter disk member 17, which advantageously rotates in the opposite direction to the direction of rotation of the toothed blade 15, facilitates deformation of the trimming and obliged passage thereof between the disk members 15 and 17.

Continuing rotation of the trimming along the trajectory T downwards, between the rotor 5 and the curved surface 37, the web material becomes completely detached due to the suction through the duct 47, while the tubular core A remains engaged with the respective engaging element 9 until it passes between the brushes 41 which remove any fragments of turns of web material and subsequently falls into the space 43 under the rotor 5 when no longer supported by the surface 37.

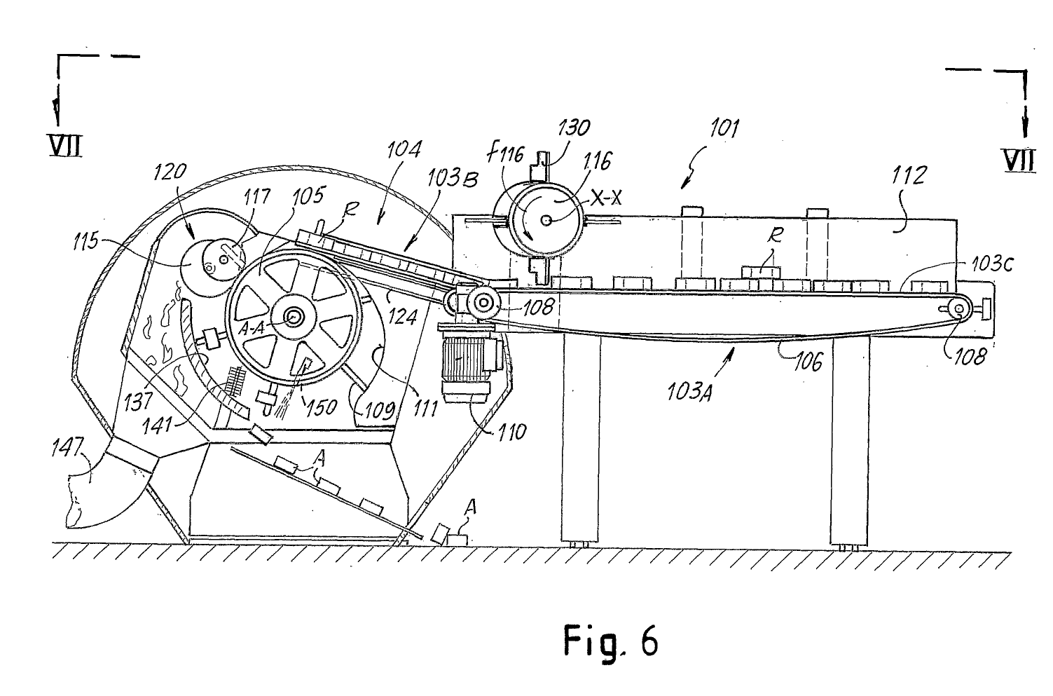

FIGS. 6 to 9 show a different embodiment of the device according to the invention. Equal parts are designated with the same reference numbers increased by 100.

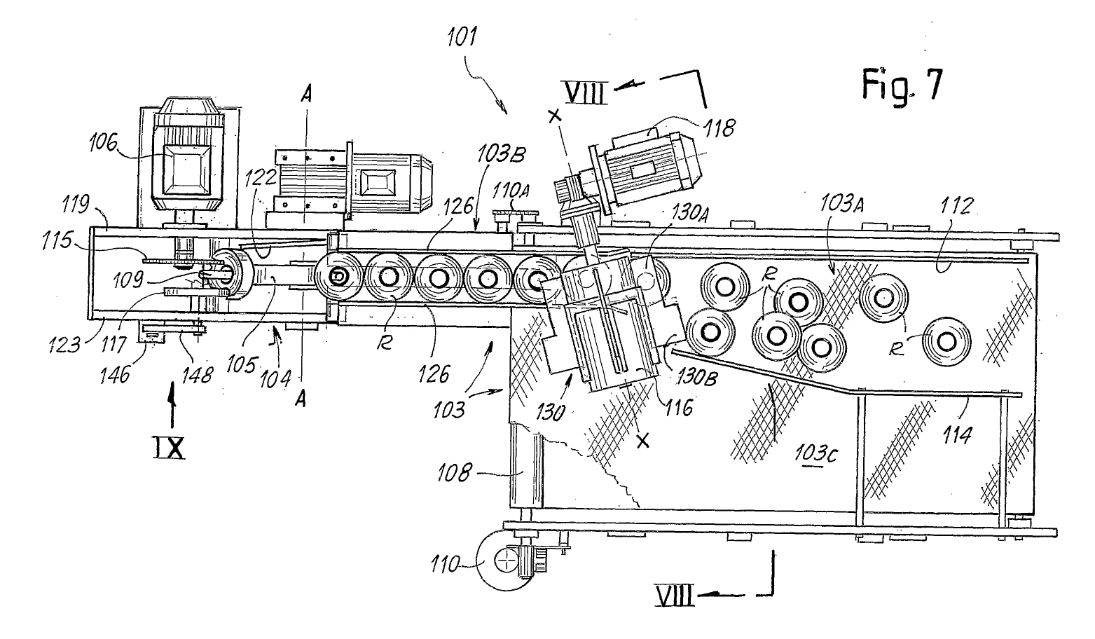

The device is thus designate 101 as a whole. 103 indicates a trimming conveyor for conveying trimmings towards head 104 of the machine. Conveyor 103 is divided into two parts 103A and 103B (see FIGS. 6 and 7). Part 103A substantially includes a belt 103C having a substantial width, guided around rollers 108, one of which is driven into rotation by motor 110. Above belt 103C a first side panel 112 and a second side panel 114 are arranged, the second one in an approximately central position. The latter side panel is shaped such as to direct the trimmings towards a rotating drum 116, which is driven into rotation by a motor 118. Arrow f16 (FIG. 6) indicates the direction of rotation of drum 116.

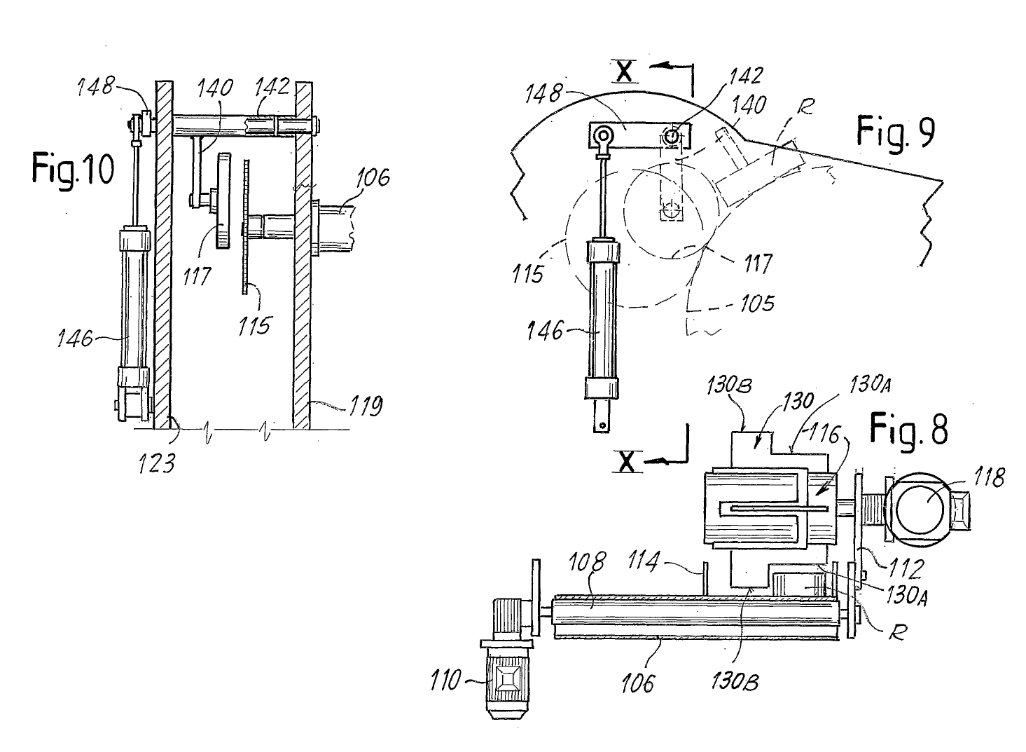

Along the periphery of the rotating drum 116 tabs 130 are arranged, which are provided with a stepped profile with portions 130A and 130B having differing radial dimensions. Portion 130A has a lower radial dimension than portion 130B. The distance between belt 103A and the rotation axis X-X of drum 116 and the radial dimension of portions 130A, 130B of the tabs are such that trimmings R can pass underneath portion 130A but not underneath portion 130B of each tab 130 (see FIG. 8). Thus, each trimming that comes in front of portion 130B of tabs 130 of drum 116 are rejected backwards. The arrangement is such that the trimmings are caused to move towards side panel 112 substantially aligned to the intake bf conveyor 103B. The latter substantially includes a conveyor belt 124 having a width which is approximately equal to or slightly larger than the diameter of trimmings R and is provided with side panels 126. Conveyor belt 124 is driven into motion by the same motor 110 through a chain transmission 110 (FIG. 7).

Conveyor belt 124 is aligned to moving member 105 formed by a rotor which rotates around a substantially horizontal axis A-A, similar to what has been disclosed in connection with the embodiment of FIGS. 1 to 5. The shape of rotor 105 is substantially equivalent to that of rotor 5 and therefore will not be described in greater detail. Reference 120 indicates as a whole a detaching device, functionally equivalent to device 20 and co-acting with rotor 105. Different to what is shown in FIGS. 1-5, the detaching device 120 does not include a counter-arm and includes two disk members 115, 117, of which member 115 is driven into rotation by a motor 106 arranged on the outside of the respective side wall 119 and is substantially formed by a serrated blade, similar to disk member 15. Conversely, disk member 117 is mounted idly at the end of an oscillating arm 140 (see in particular FIGS. 9 and 10), whose opposite end is rigidly connected to a shaft 142 which is substantially parallel to axis A-A of rotor 105 and pivotally supported around its own axis on side walls 119 and 123. A lever 148 that is in turn torsionally connected to shaft 142 and hinged to the rod of a cylinder-piston actuator 146, controls the oscillation of shaft 142. The arrangement is such that idle disk member 117 is pushed towards and against rotor 105 by means of actuator 146.

The two disk members 115 and 117 are not coaxial, as in the example shown in FIGS. 1 to 5, but have parallel axes, which are spaced apart from one another. The arrangement of the disk members 115, 117 replaces the combination of disk members 15, 17 and arm 31. Each trimming R is caused to pass between the disk members 115, 117 which are mutually juxtaposed and facing each other (FIG. 7), arranged at a distance which is less than the diameter of the trimmings. Consequently, the trimmings are squeezed and forced to pass between disk members 115, 117 as they are pulled by engaging elements or rods 109 carried by rotor 105. Disk member 115, in the shape of a serrated disk blade, cuts the web material wound around the core A of the trimmings R, which is pushed against the rotor 105 and the disk blade 115 by the idle disk 117. The cut material is sucked by suction duct 147, while the winding cores A are removed from the rods 109 as they fall down. IN the lower portion of rotor 105 members are arranged which facilitate withdrawal of the winding cores A of trimmings R. In the embodiment shown such members are formed by one or more compressed air nozzles 150, which are oriented toward the bottom.

It is understood that the drawing only shows an example provided purely as a practical embodiment of the invention, which may vary in forms and arrangements without however departing from the scope of the concept on which said invention is based.

1-52. (canceled)

53. A device for handling trimmings of logs of web material wound on tubular cores to separate turns of said web material from said tubular cores, wherein said device comprises a moving member, and engaging elements positioned around said moving member to axially engage said trimmings, said moving member being constructed and arranged to continuously feed said engaging elements along a closed path; and, along the closed path of said engaging elements, a detaching device constructed and arranged to detach turns of web material from tubular cores.

54. The device as claimed in claim 53, wherein said detaching device comprises two rotating disk members positioned on opposite sides of the closed path of said engaging elements, acting on the trimmings to detach the turns of web material from the tubular cores.

55. The device as claimed in claim 54, wherein said two rotating disk members are positioned on two approximately parallel and spaced apart planes, between which the closed path of said engaging elements passes.

56. The device as claimed in claim 55, wherein said two rotating disk members face each other and are arranged on substantially parallel planes, said engaging elements positioned to move between said two rotating disk members and substantially parallel thereto.

57. The device as claimed in claim 54, wherein at least one of said two rotating disk members is a blade.

58. The device as claimed in claim 55, wherein at least one of said two rotating disk members is a blade.

59. The device as claimed in claim 56, wherein at least one of said two rotating disk members is a blade.

60. The device as claimed in claim 57, wherein one of said two rotating disk members is a counter disk member with a smooth circular edge.

61. The device as claimed in claim 60, wherein said counter disk member is idly mounted and said blade is motor-driven.

62. The device as claimed in claim 60, wherein said contrast disk member is carried by an oscillating arm which is pushed against said moving member around which said engaging elements are arranged.

63. The device as claimed in claim 53, wherein said two rotating disk members rotate in opposite directions.

64. The device as claimed in claim 53, wherein said two rotating disk members rotate about coinciding axes.

65. The device as claimed in claim 54, wherein said two rotating disk members rotate about axes substantially orthogonal to an axis of the trimmings which pass between said two rotating disk members.

66. The device as claimed in claim 54, wherein said two rotating disk members are positioned substantially parallel to each other at a distance less than an outer diameter of the tubular cores of said trimmings.

67. The device as claimed in claim 53, wherein said detaching device includes a counter arm.

68. The device as claimed in claim 54, wherein said detaching device includes a counter arm and said counter arm is positioned between said two rotating disk members and holds each of said trimmings engaged with a respective one of said engaging elements when said two rotating disk members act thereon.

69. The device as claimed in claim 68, wherein said counter arm is stressed elastically towards said moving member.

70. The device as claimed in claim 67, wherein said counter arm is oscillating about an axis substantially parallel to the axes of rotation of said two rotating disk members.

71. The device as claimed in claim 53, further comprising brushes positioned along said closed path, downstream of the detaching device, to eliminate fragments of said turns of web material from the tubular cores.

72. The device as claimed in claim 53, further comprising a station positioned along said closed path to unload the tubular cores from the engaging elements, wherein said cores are unloaded by gravity.

73. The device as claimed in claim 53, further comprising suction members positioned along said closed path to suck up the web material forming said turns detached from the tubular cores.

74. The device as claimed in claim 53, wherein said engaging elements are provided with a movement with respect to said moving member to engage in said tubular cores of the trimmings.

75. The device as claimed in claim 74, wherein said engaging elements are retractable inside a rotor and protractable from said moving member to be inserted into the tubular cores of the trimmings.

76. The device as claimed in claim 75, wherein said engaging elements are radially arranged on said rotor.

77. The device as claimed in claim 76, wherein said engaging elements are radially retractable in said rotor and radially extractable therefrom.

78. The device as claimed in claim 75, wherein said engaging elements are elastically stressed towards a protracted position and a shaped profile is positioned along said closed path to push a respective one of said engaging elements inside the moving member, releasing the engaging elements in a position in which said trimmings are fed, elastic protraction of the engaging elements causing insertion of the engaging elements into the cores of the trimmings which are fed to said position.

79. The device as claimed in claim 53, wherein said moving member includes a rotor along a perimeter extension of which said engaging elements are positioned.

80. The device as claimed in claim 54, wherein said moving member includes a rotor along a perimeter extension of which said engaging elements are positioned and wherein said rotor rotates about an axis substantially parallel to an axis of rotation of said two rotating disk members.

81. The device as claimed in claim 79, wherein said rotor rotates about a substantially horizontal axis.

82. The device as claimed in claim 53, wherein said engaging elements include pins insertable into said tubular cores of the trimmings.

83. A method for separating a web material wound around tubular winding cores in trimmings obtained by cutting logs of said web material, comprising feeding each of said trimmings between two opposed rotating disk members, including arranging said two rotating disk members opposite and facing each other and with axes of said disk members substantially orthogonal to axes of the trimmings that pass between said two rotating disk members, wherein at least one of said disk members is motor-driven.

84. The method as claimed in claim 83, including arranging said two rotating disk members on substantially parallel planes between which said trimmings are caused to pass.

85. The method as claimed in claim 83, wherein both of said two rotating disk members are motor-driven.

86. The method as claimed in claim 84, wherein both of said two rotating disk members are motor-driven.

87. The method as claimed in claim 83, wherein one of said two rotating disk members is idly supported.

88. The method as claimed in claim 87, wherein one of said two rotating disk members is idly supported.

89. The method as claimed in claim 83, including cutting the web material by an edge of a first one of said two rotating disk members, pushing the trimmings against said first one of said two rotating disk members by a second one of said two rotating disk members.

90. The method as claimed in claim 83, including forcibly introducing each of said trimmings between said two rotating disk members and cutting turns of the web material wound around said trimmings by at least one of said two rotating disk members along a plane substantially tangential to the tubular cores.

91. The method as claimed in claim 90, including arranging said two rotating disk members facing each other at a distance less than an outer diameter of the tubular cores of the trimmings and passing each trimming therebetween, causing deformation by deflection between the two rotating disk members.

92. The method as claimed in claim 83, wherein each trimming of said trimmings is engaged with an engaging element inserted in a tubular core thereof and said engaging element is advanced between said two rotating disk members, along a trajectory substantially orthogonal to the axes of rotation of the two rotating disk members, forcing the trimming to pass therebetween by the engaging element.

93. The method as claimed in claim 83, wherein each trimming of said trimmings is held engaged with a respective engaging element by a counter arm.

94. The method as claimed in claim 93, wherein said counter arm is elastically stressed against the trimming.

95. The method as claimed in claim 83, including rotating said disk members in opposite directions.

96. A device for handling trimmings of logs of web material wound on tubular cores to separate turns of said web material from said tubular cores, comprising a path along which said trimmings are fed and, along said path, two rotating disk members positioned opposite each other and positioned on two approximately parallel and spaced apart planes, between which said trimmings are fed with respective axes thereof being approximately orthogonal to axes of rotation of the two rotating disk members.

97. The device as claimed in claim 96, wherein distance between the approximately parallel planes on which the two rotating disk members lie is less than a diameter of the tubular cores.

98. The device as claimed in claim 96, comprising engaging elements to engage the trimmings, said engaging elements moving along a closed path passing between the two rotating disk members.

99. The device as claimed in claim 97, comprising engaging elements to engage the trimmings, said engaging elements moving along a closed path passing between the two rotating disk members.

100. The device as claimed in claim 96, wherein a first one of said two rotating disks members is motor-driven and provided with a cutting edge.

101. The device as claimed in claim 100, wherein said cutting edge is serrated.

102. The device as claimed in claim 100, wherein a second one of said two rotating disk members has a smooth edge.

103. The device as claimed in claim 102, wherein said second one of said two rotating disk members is supported idly.

104. The device as claimed in claim 103, wherein said second one of said two rotating disk members is supported on a movable axis.

105. A device for handling trimmings of logs of web material wound on tubular cores to separate turns of said web material from said tubular cores, comprising a path along which said trimmings are fed and, along said path, two web detaching members arranged opposite each other, positioned on two approximately parallel and spaced apart planes, between which said trimmings are fed, distance between said detaching members being less than a diameter of said trimmings.

106. The device according to claim 105, wherein said detaching members are disk-shaped.

107. The device according to claim 106, wherein said detaching members are rotating members and an axis of rotation of said detaching members is approximately parallel to one another.

108. The device according to claim 105, including trimming engaging members, moving along said path and arranged such that the trimmings are moved between said detaching members with axes of the trimmings being approximately parallel to said planes on which said detaching members are arranged.

109. The device according to claim 105, wherein at least one of said detaching members is a rotating disk shaped blade.
